(19) United States
(12) Patent Application Publication
(10) Pub. No.: US 2008/0127133 A1
(43) Pub. Date: May 29, 2008

(54) AGGREGATING PORTLETS FOR USE WITHIN A CLIENT ENVIRONMENT WITHOUT RELYING UPON SERVER RESOURCES

(75) Inventors: AMIT R. AGHARA, BOCA RATON, FL (US); RAHUL S. KURANE, AUSTIN, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/564,110

(22) Filed: Nov. 28, 2006

(51) Int. Cl. G06F 9/45

(52) U.S. Cl. 717/140

(57) ABSTRACT

The present invention discloses a client portlet container that permits portals to be utilized in a client only environment. That is, the present invention provides a solution that aggregates a set of portlets into a client-viewable portal page without relying upon server resources, such as resources of an application server or a portal server. The solution can be utilized by a client in either a network connected state or a disconnected state. The invention can use a client portlet container to render portlet content, which is referenced by tags of an aggregated Web page, such as a Java Server Page (JSP) file.

### BACKGROUND

1. Field of the Invention

The present invention relates to the field of portals and portlets, and, more particularly, to aggregating portlets for use in a client environment without requiring server resources at a time that the aggregated portlets are used.

2. Description of the Related Art

Providing users with Web-based interfaces on the Internet or an intranet is becoming a common business method for disseminating information. The use of Web portals and Web portlets is becoming a preferred method to provide users with customizable Web content. A Web portal is a Web site or service that offers a broad array of resources and information, such as email, search engines, advertising, user-specific reports, personalized contact and task management functions, customized news feeds, local weather, and the like. A Web portal can include multiple Web portlets. Many portals permit user configurable settings and allow a user to customize a page layout to suit their preferences. For example, a portal user can customize a page layout to selectively include/exclude portlets for weathter, email notifications, calendaring, newsfeeds, and the like.

Each portlet contained within a portal, or aggregated Web page, is a user facing component. Web portlets are generally presented within a portlet container and can include static as well as dynamic content. Each portlet can be associated with portlet specific content source, which can be a different source from that associated with the portal or from that associated with other portlets. Similar to portals, portlets can include user customization features, such as customizing a weather portlet to provide weather forecast for a region local to the user.

Portlets are designed to run in an aggregated fashion and not to consume a whole response or view. That is, by nature, portlets always share a Web page with other portlets. For this reason, existing portlet specifications, such as JAVA Specification Request (JSR) 168, do not include a mechanism for direct access to portlets, such as using a URL. Instead, access is left to a portal application and its aggregation framework. For example, basic capabilities to aggregate multiple portlets on a Web page are supported by standardized libraries, such as the JAVA Server Page (JSP) tag library.

Conventional Web portal architectures rely solely upon a portal server, or an application server performing a portlet serving function, to dynamically aggregate portlet content into a resultant portal page, such as a portal JSP. In order to perform dynamic aggregation, the portal server utilizes a substantial quantity of computing resources, such as processing cycles, memory, and bandwidth. For each aggregated portlet, a server-side portlet container provides a core set of services to instantiate, invoke, and destroy portlets. Portal level aggregation functions manage input/output for each portlet, data conveyances between the portal and each portlet, page level refresh operations, and the like.

No known solution exists that permits a client to utilize a set of portlets in absence of a portal server. For example, no existing solution permits a client device to render a portal when the client device lacks network connectivity. As more and more productivity applications (such as desktop office suites) are implemented using Web based technologies (such as portals), an inability to operate in an offline state can be a major shortcoming. For instance, it would be beneficial if a portal based software solution continued to function when offline, even if some functionality were degraded (i.e., functionality explicitly dependent upon network connectivity can be automatically disabled when a client is offline).

Additionally, permitting portals to function within a client-only environment would permit portal-based software applications developed for enterprises to be scaled downwards for small businesses lacking an enterprise's information technology (IT) infrastructure, within which a portal server is typically included. This can open up new markets for software developers, who would be able to leverage their existing enterprise-level software applications to create small business solutions. Further, permitting a client-only variant of a portal based software solution for small businesses and/or entities permits a scalable upgrade pathway, which does not require significant user retraining. Despite these potential advantages, no known solution or system exists that allow clients to utilize portals in a client only environment.

### SUMMARY OF THE INVENTION

The present invention discloses a client portlet container that permits portals to be utilized in a client only environment. That is, the present invention provides a solution that aggregates a set of portlets into a client-viewable portal page without relying upon server resources, such as resources of an application server or a portal server. The solution can be utilized by a client in either a network connected state or a disconnected state. The invention can use a client portlet container to render portlet content, which is referenced by tags of an aggregated Web page, such as a JAVA Server Page (JSP) file.

In one embodiment, an aggregated Web page can be developed that incorporates custom tags and HTML based data designed to aggregate multiple portlets in a user interface. These aggregated Web pages can contain custom tags, which can be compiled and deployed to a client portlet container. The client portlet container can be configured to locally render these pre-compiled portal pages. In one arrangement, a tooling solution, which can be incorporated within an Integrated Development Environment (IDE), can be provided that permits software developers to create the aggregated Web pages the include the custom tags. In another arrangement, a development translator tool can be used to automatically generate an aggregated Web page from an existing portal configuration file. In still another arrangement, the translator tool can be a runtime translation engine that automatically generates an aggregated Web page from a portal configuration file.

The present invention can be implemented in accordance with numerous aspects consistent with material presented herein. For example, one aspect of the present invention can include a method for aggregating and utilizing portlets. The method can include a step of identifying an aggregated Web page within a client environment, where the aggregated Web page specifies a portal. Control links can be established in the aggregated Web page to one or more portlets, each link being associated with a client portlet container. Portlet content can be inserted from portlet pages or portlet applications into each client portlet container. The aggregated Web page can be rendered in a browser interface of the client environment.

Another aspect of the present invention can include a portlet handling method. In the method, a pre-compiled portlet aggregation page can be generated, which is conveyed to a client. The client can render content of the portlet aggregation page without relying upon server resources. For example, the client can use one or more client-side portlet containers referenced by the page to render portlet content.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for rendering a portal in a client only environment in accordance with an embodiment of the inventive arrangements disclosed herein.

FIG. 2 is a schematic diagram a developmental tooling solution used in conjunction with a portal solution functioning in a client only environment in accordance with an embodiment of the inventive arrangements disclosed herein.

FIG. 3 is a flow chart illustrating various solutions for creating aggregate pages that are able to be utilized in a client environment in accordance with an embodiment of the inventive arrangements disclosed herein.

FIG. 4 is a flow chart of a method, where a service agent can configure a system that permits the rendering a portal in a client only environment in accordance with an embodiment of the inventive arrangements disclosed herein.

### DETAILED DESCRIPTION OF THE INVENTION

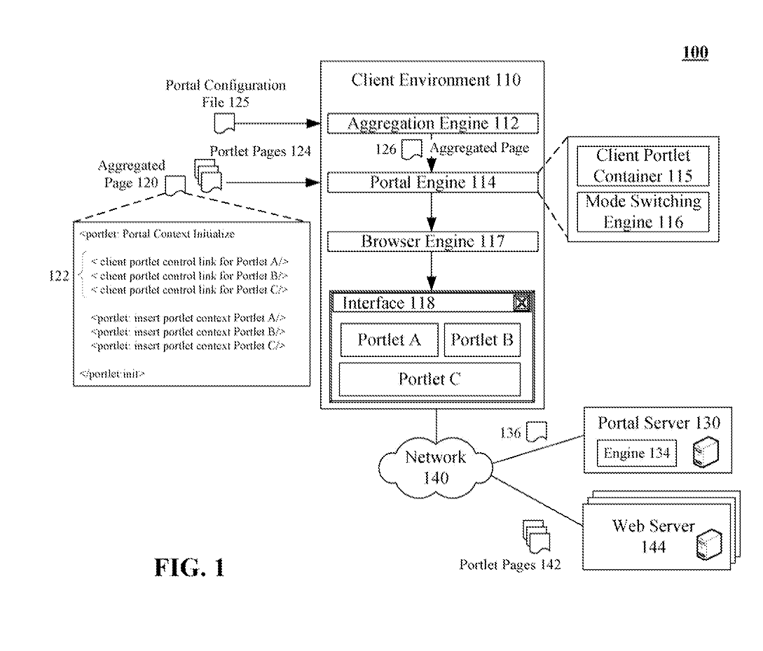

FIG. 1 is a schematic diagram of a system 100 for rendering a portal in a client only environment 110 in accordance with an embodiment of the inventive arrangements disclosed herein. Unlike traditional portal implementations that are dependent upon a server-side portal application and aggregation framework, system 100 permits portals to be rendered in a client environment 110.

More specifically, a portal engine 114 can receive an aggregated page 120, which can be a precompiled Web page 120 that includes embedded tags 122. These can be special tags 122 for providing a control link for a special client-side portlet container 115 within which portlet content 124 can be rendered. The browser engine 117 can render the aggregated page 120 in a client-side interface 118. The interface 118 can include, for example, a Portlet A, a Portlet B, and a Portlet C, having a layout specified by aggregated page 120. Content for each Portlet A-C can be provided by a specific portlet page 124, which is linked to a client portlet container 115. Because the client environment 110 can render a portal without server-side resources, environment 110 is able to operate in a network 140 disconnected mode.

In one embodiment, a mode switching engine 116 can be included in environment 110 to enable system 100 to operate in a connected mode, in which updated content is received. In a connected mode, content for Portlets A-C can be obtained from portal pages 142 from Web servers 144 instead of from locally stored portlet pages 124. The portlet pages 124 can be locally cached pages that were previously obtained from Web server 144 that last time environment 110 was in a connected state. That is, when environment 110 obtains pages 142, these pages 142 can automatically replace previously cached pages 124 in a local data store. If connectivity to network 140 is lost, the most recently cached pages 124 can be used to provide the portlet content.

In another embodiment, the mode switching engine 116 can substitute a server 130 provided aggregated page 136 for page 120 when in a connected state. When this is done, portal engine 134 of server 130 is utilized instead of portal engine 114. Moreover, content of aggregated page 120 can be obtained from the server 130 so that aggregated page 120 is updated to match any updates that are reflected within aggregated page 136.

In still another embodiment, the client environment 110 can include an internal aggregation engine 112, which creates an aggregated page 126 from a portal configuration file 125. Page 126 can also include special tags 122 for client portlet container 115 and can, therefore, be handled by environment 110 in the same manner page 120 was handled. When an aggregated engine 112 is included in environment 110, updated portal configuration files 125 can be intermittently received from server 130, which results in intermittently updated aggregated pages 126.

As used herein, both of the portal engines 114 and 134 can include one or more portal applications that define a specific aggregation framework. The portal application and framework of engine 114 can be customized for environment 114, which can be a resource limited environment. Engine 114 can have a relatively small footprint that executes with minimal processing power. In contrast, engine 134 can have more robust capabilities than it's functional equivalent engine 114. Code can be written for both engines 114 and 134 in a manner that allows for the seamless degradation of functionality. That is, even though portlet code can take advantage of robust features provided by engine 134 that are not supported by engine 114, the portlet code can still execute within environment 110, albeit with potentially reduced features.

The portlet engines 114 and 134 can both conform to a similar standard. For example, both engines 114 and 134 can be based upon JAVA Specification Request (JSR 168). The system 100 is not limited to any particular portal, portlet container standard but can be adapted to any specification. For example, the engines 114 and 134 can be based upon a Web Services for Remote Portlets Specification (WSRP) based technology, a .NET platform based technology, a SHAREPOINT based technology, an ASP based portal technology, a PHP based portal technology, and the like.

Further regardless of the standard and/or technology upon which engines 114 and 134 are based, engine 114 can be compatible with many different implementations of a portal server 134. For example, the engine 114 can be compatible with engine 134, regardless of whether portal server is a WEBSPHERE APPLICATION SERVER or a WEBSPHERE PORTAL, which are both specific portal servers by International Business Machines Corporation (IBM) of Armonk, N.Y. The WEBSPHERE Portal can extend JSR 168 capabilities with additional features not implemented for the WEBSPHERE APPLICATION SERVER such as probe portlet services events, and other capabilities such as property broker events, portlet services events, and other capabilities. The same JSR 168 based engine 114 can also be compatible with portal server 130 implementations, such as the BEA WEBLOGIC PORTAL, LIFERAY, JBOSS, PLUTO, GRIDSPHERE, UPORTAL, and the like.

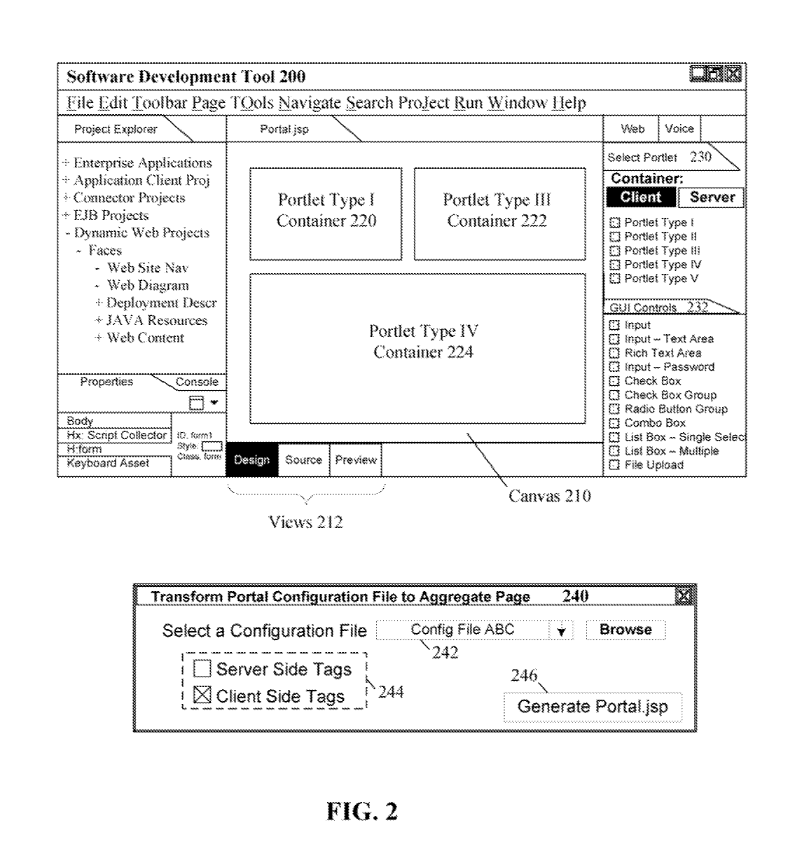

FIG. 2 is a schematic diagram of a developmental tooling solution used in conjunction with a portal solution functioning in a client only environment in accordance with an embodiment of the inventive arrangements disclosed herein. In one embodiment, shown by interface 200, a graphical software development tool 200 can be used to generate an aggregated page that includes tags for client portlet containers. The tool 200 can be part of an integrated development environment (IDE), such as the RATIONAL APPLICATION DEVELOPER (RAD) tool by IBM.

As shown, the tool 200 can have a canvas 210 upon which a designer can drag GUI controls 232 and different portlets 230. The portlet toolbar 230 can include designer selectable options indicating which type of portlet container (a client-side portlet container and/or a server-side portlet container) is to be referenced by the portal.jsp. Different types of portlets, shown as types I-V, can be available via tool 200. A designer can drag different portlets to the canvas 210 and can graphically manipulate their layout. As shown, canvas 210 can include three portlets 220-224 of different types within a portal being developed. Once portlet containers 220-224 are defined, container properties can be adjusted using tool 200. For example, a user can specify a portlet content source for each portlet container. Different available views 212 can present a design layout, a source or code layout, and/or a preview layout.

In another embodiment shown by interface 240, a translator used by a developer can automatically generate an aggregated page from a portal configuration file. The interface 240 can permit a developer to select 242 a configuration file. The interface 240 can optionally permit a user to select what type 244 of portlet tags are to be included in an aggregated page. Finally, a selectable button 246 can be included that generates an aggregated page based upon the selected 242 configuration file.

Both tooling solutions provided above provide a means for a developer to create a precompiled aggregated page, such as page 120, which can be conveyed to a client. The client can be a client used in a development environment or a client used in a runtime environment. For example, developers working on portlets can develop their portlet component locally using a client-side portlet container. Once initial efforts are completed, the developer can utilize a server-side portlet container to test how the portlet will function in an online mode. In one embodiment, the software development tool can mimic or simulate online and offline states of a runtime environment. It should be appreciated that the arrangements, layout, and control elements for GUIs 200 and 240 have been provided for illustrative purposes only and derivatives and alternates are contemplated herein and are to be considered within the scope of the present invention.

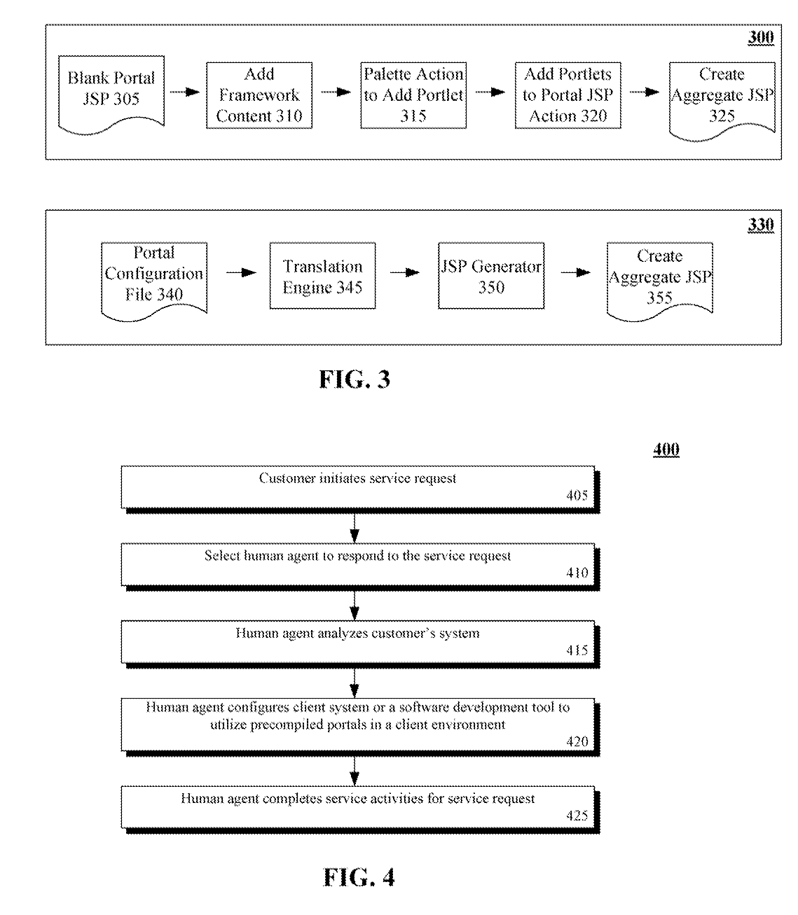

FIG. 3 is a flow chart illustrating various solutions 300 and 330 for creating aggregate pages that are able to be utilized in a client environment in accordance with an embodiment of the inventive arrangements disclosed herein. The solutions 300 and/or 300 can operate in the context of system 100.

Solution 300 illustrates a tooling solution that accepts a blank JSP file and a set of portlets as input. It produces output of an aggregated JSP that contains a series of tags, each representing a portlet application. Solution 300 can start with a blank portal JSP 305 to which framework content 310 is added. This content can be added using a tooling solution, such as interface 200. That is, a palette action to add a portlet 315 can be performed using the tooling solution 320, which adds portlets to the JSP. The created JSP 325 can be pre-compiled and deployed to a client portlet container (e.g., container 115), which renders the included content.

The solution 330 can represent actions performed by aggregation engine 112 and/or a development translation tool, such as shown by interface 240. Solution 330 accepts a portal configuration file, a set of portlets, and an optional blank JSP file as input. When no blank JSP file is input, one can be automatically generated. Solution 330 can output an aggregated JSP that contains a series of tags, each representing a portlet application. For example, each configuration file entry can be associated with a tag entry of the JSP. In one embodiment, the tags can be arranged in a table format. As shown, a portal configuration file 340 can be conveyed to translation engine 345, which produces results for the JSP generator 350. The JSP generator 350 can create an aggregate page 355 that is pre-compiled and deployed to a client portlet container (e.g., container 115), which renders the included content.

FIG. 4 is a flow chart of a method 400, where a service agent can configure a system that permits the rendering a portal in a client only environment in accordance with an embodiment of the inventive arrangements disclosed herein. Method 400 can be preformed in the context of system 100.

Method 400 can begin in step 405, when a customer initiates a service request. In step 410, a human agent can be selected to respond to the service request. In step 415, the human agent can analyze a customer's current system and can develop a solution. In step 420, the human agent can configure a client system or a software development tool to use precompiled portals in a client environment. In step 425, the human agent can complete the service activities.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for aggregating and utilizing portlets comprising:
identifying an aggregated Web page within a client environment said aggregated Web page specifying a portal;
establishing control links in the aggregated Web page to a plurality of portlets, each associated with a client portlet container;
inserting portlet content from portlet pages into each client portlet container; and
rendering the aggregated Web page in a browser interface of the client environment.

2. The method of claim 1, wherein the aggregated Web page is precompiled within a computing device external to the client environment, said method further comprising:
conveying the aggregated Web page from the external computing device to the client environment.

3. The method of claim 1, further comprising:
conveying a portal configuration file to the client environment; and
an aggregation engine in the client environment transforming the portal configuration file to the aggregated Web page.

4. The method of claim 1, wherein a software development tool automatically transforms a portal configuration file into the aggregated Web page, which is thereafter conveyed to the client environment.

5. The method of claim 1, further comprising:
a software development tool adding portlets to a blank aggregated Web page responsive to a developer initiated palette action;
pre-compiling the aggregated Web page using the software development tool; and
conveying the aggregated Web page to the client environment.

6. The method of claim 1, wherein the rendering step occurs when the client environment is in an offline state.

7. The method of claim 1, further comprising:
shifting the client environment from an offline state to an online state, wherein when in the online state the portlet content is obtained from at least one Web server remotely located from the client environment.

8. The method of claim 1, further comprising:
when in the online state, obtaining an second aggregated Web page that corresponds to the aggregated Web page from a portal server, wherein said second aggregated Web page is dynamically compiled within the portal server; and
rendering the second aggregated Web page in the browser interface.

9. The method of claim 1, wherein the aggregated Web page is a JAVA Server Page (JSP).

10. The method of claim 1, wherein the client portlet container complies with a standard based upon JAVA Specification Request (JSR) 168.

11. The method of claim 1, wherein said steps of claim 1 are performed by at least one machine in accordance with at least one computer program having a plurality of code sections that are executable by the at least one machine.

12. The method of claim 1, wherein the steps of claim 1 are performed by at least one of a service agent and a computing device manipulated by the service agent, the steps being performed in response to a service request.

13. A portlet handling method comprising:
generating a pre-compiled portlet aggregation page;
conveying the pre-compiled portlet aggregation page to a client; and
the client rendering content of the portlet aggregation page without relying upon server resources.

14. The method of claim 13, wherein the rendering step occurs when the client is in an offline state.

15. The method of claim 13, wherein the generating step is performed by a software development tool.

16. The method of clam 13, wherein the generating step automatically generates the portlet aggregation page from a portal configuration file.

17. The method of claim 13, wherein the portlet aggregation page includes tags that reference a client-side portlet container, which is used by the client to render portlet content.

18. The method of claim 13, wherein the portlet aggregation page is a JAVA Server Page (JSP).

19. The method of claim 13, wherein the portlet aggregation page conforms to a standard based upon JAVA Specification Request (JSR) 168.

20. The method of claim 13, wherein said steps of claim 13 are performed by at least one machine in accordance with at least one computer program having a plurality of code sections that are executable by the at least one machine.
